(19) United States
(12) Patent Application Publication
(10) Pub. No.: US 2012/0281799 A1
(43) Pub. Date: Nov. 8, 2012

(54) Irradiation Device and Method for Preparing High Specific Activity Radioisotopes

(76) Inventors: Douglas P. Wells, Pocatello, ID (US); Frank Harmon, Pocatello, ID (US)

(21) Appl. No.: 13/100,324

(22) Filed: May 4, 2011

(51) Int. Cl. G21G 1/12; G21G 1/10

(52) U.S. Cl. 376/157; 376/190

(57) ABSTRACT

Using the device and method of the present invention, high energy photons, or gamma radiation, impinge upon a target comprising a nanomaterial that includes a target isotope, resulting in the release of one or more neutrons from the target isotope. This neutron release creates an effect known as “kinematic recoil,” which results in a recoiling photo-produced radioisotope which is ejected from the nanomaterial and can be harvested in high specific activity.

### BACKGROUND

A radioisotope is an atom with an unstable nucleus, characterized by an ability to emit particles and attain a lower state of energy. Instability in the radioisotope nucleus results in radioactive decay and emission of gamma rays and/or subatomic particles. These particles constitute ionizing radiation. Radioisotopes are useful in a variety of applications, not only as sources of radiation but also for their chemical properties. For example, radioisotopes are useful in tracer materials, food preservatives, agricultural products, detection devices, and are particularly useful in medical diagnostics and therapy.

Radioisotopes for medical uses have been estimated to be of therapeutic or diagnostic benefit to as many as 1 in 2 people in Western countries. Radioisotopes can occur naturally, but can also be artificially produced. A number of useful radioisotopes can be produced using electron accelerators through photonuclear and other nuclear reactions. However, a limitation of many radioisotopes that are artificially produced by electron accelerators is the dilution of the radioactive atoms by non-radioactive atoms that are chemically similar. Electron accelerator-produced radioisotopes therefore often result in low specific activity, defined as a low ratio of radioactivity per unit mass. Thus, photo-nuclear and other non-traditional nuclear reaction methods that result in low specific activity radioisotopes are rarely used for high specific activity radioisotope production.

Nonetheless, high specific activity radioisotopes are useful and often necessary for certain applications, such as medicine, wherein the quantity and concentration of radioisotope delivered to a patient is important. The present invention addresses these shortcomings in photonuclear radioisotope production by providing devices and methods capable of producing high specific activity radioisotopes.

### SUMMARY

The irradiation device of the invention comprises: an electron accelerator for supplying accelerated electrons; a converter comprised of a high Z material upon which the accelerated electrons impinge and which converts accelerated electron energy into gamma radiation; a target upon which the gamma radiation impinges, the target comprising (i) a first nanomaterial comprising an isotope and having at least one dimension that is 100 nm or less, and (ii) a second material adjacent to the first nanomaterial which accepts a radioisotope transmutated from the isotope of the first nanomaterial which is ejected from the first nanomaterial when the gamma radiation impinges on the target; and one or more cooling systems for cooling the converter and target during operation of the device.

The method for producing radioisotopes comprises: irradiating a target with gamma radiation, the target comprising (i) a first nanomaterial comprising a target isotope, and (ii) a second material adjacent to the first nanomaterial which accepts a radioisotope transmutated from the target isotope of the first nanomaterial which is ejected from the first nanomaterial when the gamma radiation impinges on the target.

### BRIEF DESCRIPTION OF THE DRAWINGS

FIG. 1 is an elevation, partial cut-away view of the irradiation device described herein.

FIG. 2A is a partial cross-sectional top (or side) view of an exemplary target described herein.

FIG. 2B is a cross-sectional view of an exemplary target described herein.

FIG. 2C is partial cross-sectional top (or side) view of an exemplary target described herein.

FIG. 3 is a plot of recoiled ⁹⁹Mo energy.

FIG. 4 is a plot of ⁹⁹Mo range in natural molybdenum as a function of its energy.

FIG. 5 is plot of Bremsstrahlung-weighted path-length of recoiling ⁹⁹Mo.

FIG. 6 is a plot of ⁹⁹Mo escape fraction as a function of nanoparticle size.

FIG. 7 is a plot of calculated and measured escape fractions determined from Example 2.

### DETAILED DESCRIPTION

Using the device and method of the present invention, high energy photons, or gamma radiation, impinge upon a target comprising a nanomaterial that includes a target isotope, resulting in the release of one or more neutrons from the target isotope. This neutron release creates an effect known as “kinematic recoil,” which results in a recoiling photo-produced radioisotope. When the kinetic energy of the photo-produced radioisotope is large enough, the radioisotope can completely eject from the nanomaterial. Upon ejection, the radioisotope can travel into a catcher material (second material) that is adjacent to the target nanomaterial. The resulting radioisotope in the second material has high specific activity and can be harvested from the second material in highly pure form, given that the remaining unreacted isotope remains in the target nanomaterial.

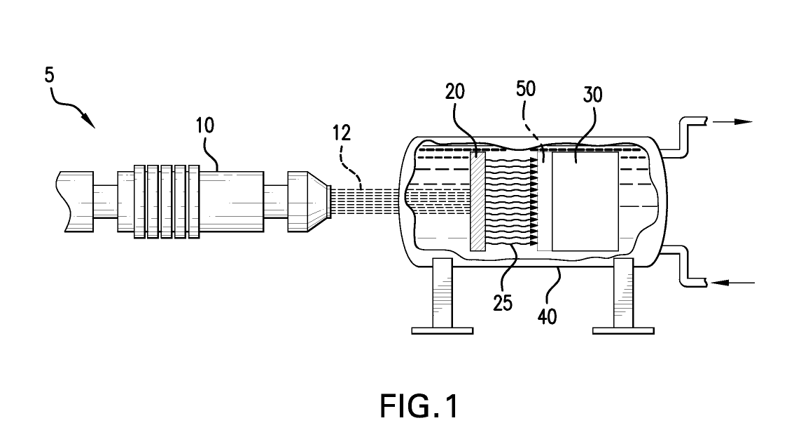

Referring now to FIG. 1, the irradiation device 5 of the invention comprises an electron accelerator 10 for supplying accelerated electrons to converter 20, which then converts the accelerated electrons into high energy photons, or gamma radiation. The electron accelerator 10 generates electrons through a cold cathode, a hot cathode, a photocathode, or a radio frequency (RF) ion source. Energy of the generated electrons is increased by subjecting the electrons to oscillating electric potentials directed along a linear beamline to produce accelerated electron beam 12. Electron accelerator 10 is preferably a linear particle accelerator (often referred to as a “linac”), which uses a radiofrequency ion source.

Electron beam 12 has an energy of at least 10 MeV, and preferably an energy ranging from 10 MeV to 100 MeV. The specific desired energy of electron beam 12 can be determined based on desired production rates of the radioisotope of interest. Production rates of a few non-limiting radioisotopes are provided in Table 1 in terms of radioactivity (in curies, Ci) per week, when using a 50 MeV electron beam energy.

TABLE 1
Approximate radioisotope production rates
using a 50 MeV, 100 kW electron beam.

| | Yield per 100 kW per week from 100 g | |
|---|---|---|
| Isotope | targets at 50 MeV electron beam energy | |
| ¹⁸F | 9 | kCi/wk |
| ⁶⁴Cu | 10 | kCi/wk |
| ⁶⁷Cu | 1 | kCi/wk |
| ¹³¹Ba/¹³¹Cs | 15 | kCi/wk |
| ⁹⁹Mo/^{99m}Tc | 2 | kCi/wk |
| ¹¹¹In | 2 | kCi/wk |
| ⁸⁸Y | 6 | Ci/wk |
| ⁷⁵Se | 6 | Ci/wk |

Electron beam 12 has a beam power of at least 1 kiloWatt (kW), preferably a beam power ranging from 10 to 100 kW, and more preferably a beam power ranging from 10 to 40 kW. Total power of electron beam 12 can be limited by the design of electron accelerator 10 as well as the design, thickness, and heat removal capacity of converter 20. Electron beam 12 produces a current density of at least 1 microamp per cm² (μa/cm²), and preferably a current density ranging from 100 μa/cm² to 100 milliamps per cm² (ma/cm²). A higher current density ranging from 100 milliamps per cm² (ma/cm²) to 1 amp can also be used.

Electron beam 12 generated by electron accelerator 10 is directed onto converter 20, which converts accelerated electron energy into gamma radiation, or photon beam 25. Converter 20 comprises a “high Z” material, defined as a material having a Z of at least 20, where “Z” refers to atomic number. Examples of suitable high Z materials include, without limitation, tantalum, platinum, gold, tungsten, molybdenum, uranium, and lead.

Thickness of converter 20 generally depends on the beam energy of electron beam 12, composition of converter 20, and the threshold energy of the targeted isotope to be transmutated into the desired radioisotope. If converter 20 is too thick, photons emitted from the converter may be reduced in energy or quantity during passage through the converter material. If converter 20 is too thin, electrons may pass through the converter and impinge upon the target, undesirably.

Converter 20 can include an aggregate of multiple converter plates in a set or series. An example is a converter containing approximately six plates of tungsten alloy of aggregate 5 mm thickness, which can optionally be separated by cooling gaps. Another example is a thin tantalum converter comprising a set of five 0.5 mm tantalum disks.

Converter 20 generates Bremsstrahlung, or breaking radiation, as accelerated electrons impinge upon the converter material. As electrons from electron beam 12 hit converter 20, they decelerate, and converter 20 emits electronmagnetic radiation as photon beam 25, which includes gamma radiation.

The process of converting electron beam 12 into photon beam 25 can produce significant heat. Heat can be removed by cooling system 40, which can surround converter 20 and remove heat by radiation, conduction, or convection. Converter 20 can also contain cooling channels which are disposed within the material that forms the converter, through which a coolant can flow. Likewise, multiple converter plates can be separated by channels, through which coolant can flow. For very high power densities, converter 20 can be a porous metallic frit which is cooled by fluid coolant flowing through the interstices of the frit.

Cooling system 40 can include one or more ducts flowing through multiple converter and/or target segments. Coolant can be flowed through cooling system 40 during operation of irradiation device 5. Suitable coolants include liquid coolants, such as water, or other liquids or gases, such as nitrogen, that are kept at a temperature below the boiling point of the liquid. Cooling system 40 can cool converter 20, target 30, and optionally beam hardener 50.

Converter 20 can include a solid, molten, or liquid high Z material, which as discussed above can be a single material or an aggregate of multiple solid, molten, or liquid segments. A molten or liquid converter 20 can be contained in a suitable container, which can include inlet and outlet ports through which the molten or liquid converter 20 can flow or be circulated, for example, to cool the converter material during operation of the device.

The extent of convertor 20 that is in the direction of the trajectory of electron beam 12 should be sufficient to absorb a significant portion of the electron beam energy while transmitting photon radiation in an energy range suitable for the desired isotopic conversion reaction. Concurrent with transforming the energy of electron beam 12 into high energy photons in photon beam 25, convertor 20 may also shield the target from residual electrons.

The intensity of photon beam 25 generated in convertor 20 is proportional to the power density of electron beam 12 that enters the converter. The electron beam power density is generally limited by the heat removal capacity of convertor 20. Photon beam 25 contains photons having a broad Bremsstrahlung spectrum, ranging from zero energy up to the energy of electron beam 12. The electron beam power density (PD) within convertor 20 can calculated by the following equation: PD=Ei/V, where E is the energy of electron beam 12, i is the current of electron beam 12, and V is the volume of converter 20 through which electron beam 12 passes.

Beam hardener 50 is optionally positioned between converter 20 and target 30 to remove any residual electrons. Beam hardener 50 can be particularly useful when converter 20 has a thickness or aggregate thickness that is less than the electron stopping distance, in which instance electrons may pass through converter 20 without their energy being converted into photon energy. Such electrons may undesirably strike target 30.

Beam hardener 50 includes a “lower Z” material, defined as a material having a Z less than 20, wherein “Z” is atomic number. Aluminum is an example of a suitable beam hardener material. The cross-sectional area of beam hardener 50 is preferably equal to or larger than the width of photon beam 25. As an example configuration, converter 20 can include five 0.5 mm tantalum disks, discussed previously, which are spaced equally apart by a distance of about 3 mm and surrounded by a cooling medium, such as water. An aluminum beam hardener 50 having a thickness of from about 5-10 cm can be positioned adjacent to such a converter configuration.

Target 30 includes the first nanomaterial comprising the target isotope and the second material which accepts a product radioisotope ejected from the first nanomaterial as photon beam 25 impinges on target 30. Target 30 is typically sized appropriately relative to the area of high intensity of photon beam 25. The cross-sectional area of target 30 is typically equal to, or larger than, the high intensity area of photon beam 25. Depth of target 30 through which photon beam 25 passes may be determined based upon the loading of targeted isotopes in the first nanomaterial, the desired concentration of the product radioisotope, energy level of photon beam 25, and the period of irradiation. Target 30 preferably has an aggregate thickness that results in significant capture of the high energy photons in photon beam 25 which impinge on target 30. For example, target 30 can have a total depth (distance parallel to photon beam 25) of at least 1 cm and up to 20 cm or more, when exposed to a photon beam produced by a 20-50 Mev electron beam. The nanomaterial inside target 30 preferably has a depth or segmented depth of 100 nm or less. Target 30 can include multiple target segments as an aggregate or segments that are physically separable but that can be placed adjacent to one another.

The first nanomaterial in target 30 can be a large variety of nanomaterials having at least one dimension that is 100 nm or less. As will be discussed below, the first nanomaterial can be nanoparticles, nanofoils, nanowires, and the like, and can include any of those target isotopes discussed in more detail below. Dimensions of the second material in target 30 are not restrictive and can also be nano-sized dimensions (e.g., 100 nm or less) or larger, including micron or larger sized dimensions. The second material can be in a liquid, solid, slurry, gas, or any suitable physical form.

Target 30 can include the target isotope in the first nanomaterial in a particulate, solid, liquid, slurry, gas, or any physical form. The target isotope can be the nanomaterial itself, i.e., the first nanomaterial consists of the target isotope. Alternatively, the target isotope can be contained within, or form a portion of the first nanomaterial. An example of which is a Mo nanoparticle, at least a portion of which is ¹⁰⁰Mo. Another example is a hydrocarbon, or fluorinated hydrocarbon, such as a TEFLON nanomaterial or nanoparticle, which includes ¹⁹F, but which also includes other elements, including carbon, etc. A similar example is a carbon nanotube, which includes the target isotope ¹²C. Likewise, the target isotope can be one or more atoms in a chemical compound, such as a small organic molecule or polymer, that forms or is contained within at least a portion, or all, of the first nanomaterial.

Target 30 can include a liquid as part of the first nanomaterial, discussed previously, or as part or all of the second material. In this instance, target 30 can include an appropriate container for containing the liquid, particularly when the second material is or contains liquid. Such a container should not result in a significant reduction in the power of photon beam 25 or create a significant increase in the scatter of photons from photon beam 25. An example of a suitable container material is titanium or aluminum.

At least a portion of photons from photon beam 25 strike target 30 and induce a reaction in the target isotope, which is the first nanomaterial, or is present within or is a portion of the first nanomaterial, as discussed above. The isotopic conversion reaction can include (γ,n), (γ,2n), (γ,p), (γ,2p), (γ,α), (γ,2α), or (γ,pn) reactions. The invention is particularly useful when (γ,n) and (γ,2n) reactions occur and result in radioisotopes that are chemically identical to and thus difficult to separate from the parent isotopes. Non-limiting examples of target isotopes and the corresponding product radioisotope produced are listed in Table 2. Target 30 can include one or more of the target isotopes bolded in Table 2 (right-most column), among others. Likewise, the second material, which accepts the radioisotope ejected from the first nanomaterial as photon beam 25 impinges on target 30, can include one or more of the product radioisotopes listed in Table 2 (left-most column), in any concentration, after a period of irradiation.

TABLE 2
Photo-reaction produced radiosotopes ordered by atomic number (Z).

| Radioisotope | Half- | | Decay | Photons emitted | Target isotope |
|---|---|---|---|---|---|
| produced | life* | | mode | (keV) | reaction(s)** |
| ⁷Be | 53.3 | d | ε | γ 478 | ⁹Be (γ, 2n)⁷Be |
| ¹¹C | 20.4 | m | β+ | Ann. 511* | ¹²C (γ, n)¹¹C |
| ¹³N | 10 | m | β+ | Ann. 511 | ¹⁴N (γ, n)¹³N |
| ¹⁵O | 2 | m | β+ | Ann. 511 | ¹⁶O (γ, n)¹⁵O |
| ¹⁸F | 110 | m | β+ | Ann. 511 | ¹⁹F (γ, n)¹⁸F |
| ²⁶Al | 7.2 · 10₆ | a | β+ | γ 1809, . . . | ²⁷Al (γ, n)²⁶Al |
| ⁴⁷Sc | 3.35 | d | β− | γ 159 | ⁴⁸Ti (γ, p)⁴⁷Sc |
| | | | | | ⁴⁸Ca (γ, n)⁴⁷Ca (β−)⁴⁷Sc |
| ⁵⁷Co | 271 | d | ε | γ 122, 136 | ⁵⁸Ni (γ, p)⁵⁷Co |
| ⁶⁴Cu | 12.7 | h | ε, β−, | Ann. 511, | ⁶⁵Cu (γ, n)⁶⁴Cu |
| | | | β+ | γ 1346 (weak) | ⁶⁶Zn (γ, np)⁶⁴Cu |
| ⁶⁷Cu | 62 | h | β− | γ 185, 93, . . . | ⁶⁸Zn (γ, p)⁶⁷Cu |
| ⁶⁷Ga | 78.3 | h | ε | γ 93, 185, 300 | ⁶⁹Ga (γ, 2n)⁶⁷Ga |
| ⁷⁵Se | 120 | d | ε | γ 265, 136, . . . | ⁷⁶Se (γ, n)⁷⁵Se |
| ⁷⁷Br | 57 | h | ε, β+ | γ 239, 521, . . . | ⁷⁹Br (γ, 2n)⁷⁷Br |
| ^{82m}Rb | 6.3 | h | ε, β+ | γ 776, 554, . . . | ⁸⁴Sr (γ, np)^{82m}Rb |
| ⁸⁸Y | 107 | d | ε, β+ | γ 898, 1836 | ⁸⁹Y (γ, n)⁸⁸Y |
| ⁹⁰Y | 64 | h | β− | γ 2186 (weak) | ⁹¹Zr (γ, p)⁹⁰Y |
| ⁹⁹Mo | 66 | h | β− | γ 740, 182, . . . | ¹⁰⁰Mo (γ, n)⁹⁹Mo |
| ^{110m}Ag | 250 | d | β−, IT | γ 658, 885, . . . | ¹¹¹Cd (γ, p)^{110m}Ag |
| | | | | | ¹¹²Cd (γ, np)^{110m}Ag |
| ¹¹¹In | 2.8 | d | ε | γ 245, 171 | ¹¹²Sn (γ, p)¹¹¹In |
| ¹³¹Ba/ | 11.5 | d | ε, β+ | γ 496, 216, . . . | ¹³²Ba (γ, n)¹³¹Ba |
| ¹³₁Cs | (9.7 | d) | ε | 29.8, . . . (Xe- | ¹³¹Ba (ε, β+)¹³¹Cs |
| | | | | X-rays) | ¹³¹Ba (γ, p)¹³¹Cs |
| ¹⁶⁶Ho | 26.8 | h | β− | γ 81, . . . | ¹⁶⁷Er (γ, p)¹⁶⁶Ho |
| ¹⁹²Ir | 74 | d | β−, ε | γ 317, 468, . . . | ¹⁹³Ir (γ, n)¹⁹²Ir |
| ¹⁹⁷Hg | 64.1 | h | ε | γ 77, . . . | ¹⁹⁸Hg (γ, n)¹⁹⁷Hg |
| ²⁰³Hg | 46.6 | d | β− | γ 279 | ²⁰⁴Hg (γ, n)²⁰³Hg |

*d, days; m, minutes, h, hours;
**target isotope of the first nanomaterial in bold

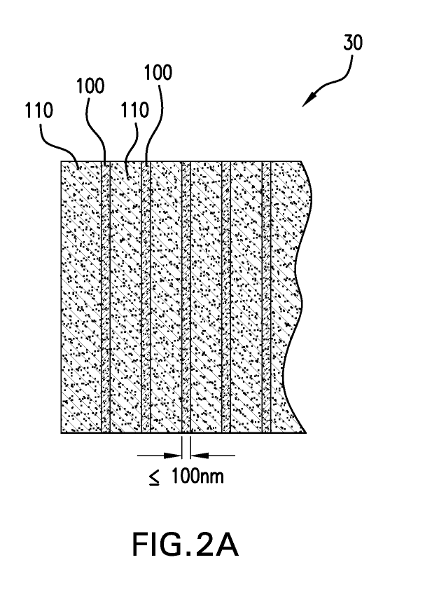

Target 30 can include the nanomaterial (including the target isotope) and second material in a variety of configurations, three non-limiting examples of which are depicted in FIGS. 2A-2C. Generally, the second material is adjacent to, or even in physical contact with the first nanomaterial, including embodiments wherein the second material surrounds the first nanomaterial. The second material, for example, can be a liquid containing the first nanomaterial suspended or dispersed therein.

With reference to the exemplary embodiment depicted in FIG. 2A, target 30 includes the first nanomaterial as multiple thin strips 100 having a thickness of 100 nm or less, defined as the depth parallel to photon beam 25 (FIG. 1). The length of strips 100, defined as the distance perpendicular to photon beam 25 (FIG. 1), can be any suitable distance, generally depending on the width of the high intensity portion of photon beam 25 (FIG. 1). Strips 100 are positioned adjacent to the second material 110, which can be any suitable depth (including depths much larger than 100 nm). Target isotopes in strips 100 react as photon beam 25 (FIG. 1) impinges on target 30 (FIG. 1) to produce product radioisotopes, which are ejected from strips 100 into the second material 110, by kinematic recoil action resulting from the ejection of one or more neutrons from the target isotope.

Depending on the particular depth of strips 100, a certain fraction of the product radioisotope (relative to the target isotope) escapes strip 100 and is ejected into the second material 110. Generally, the smaller the depth of strips 100, the larger the escape fraction, i.e., more of the product radioisotope escapes. However, with large escape fractions, the probability that an escaping product radioisotope will collide with a remaining (unreacted) target isotope in strip 100, as it is leaving, increases. Thus, a remaining (unreacted) target isotope in strip 100 may be knocked out of strip 100 and into the second material 110. Such a phenomenon may undesirably reduce the specific activity value of the product radioisotope that is present in the second material 110 after irradiation is complete. This phenomenon can be at least partially corrected by taking into account energy differences between escaping product radioisotopes and escaping unreacted target isotopes. By coating strips 100 with a thin (1 to 20 nm) coating layer (not shown), an acceptable amount of escaping unreacted target isotopes can be blocked from entering the second material 110, without blocking substantial quantities of escaping product radioisotope. Suitable coating layer materials include aluminum, gold, silicon-carbide, or carbon or other metallic, organic or inorganic compounds.

A specific non-limiting example of an embodiment in accordance with FIG. 2A comprises a target 30 having multiple strips 100 of the first nanomaterial comprising mow and having a thin coating (1-20 nm) of an element such as gold or platinum, which strips 100 are sandwiched between the second material 110, which comprises aluminum. After irradiating the target with photon beam 25 (FIG. 1), nanomaterial strips 100 and the second material 110 can be separated using mechanical or manual methods, after which the second material 110 (which contains the product radioisotope ⁹⁹Mo) can be dissolved in an appropriate solvent, leaving particulates containing product radioisotope ⁹⁹Mo, which can be filtered away, or otherwise separated from the dissolved second material 110.

Referring now to the exemplary embodiment depicted in FIG. 2B, target 30 (FIG. 1) can include nanoparticle 200 that includes the target isotope, which is surrounded by the second material 210. Optionally, a coating layer 220 can be present around nanoparticle 200, i.e., between nanoparticle 200 and the second material 210, again to prevent unwanted escape of unreacted target isotope, particularly when nanoparticle 200 is very small (i.e., when the escape fraction is large). Optional coating layer 220 can include any suitable coating layer material, specified above, such as aluminum, silicon-carbide, or carbon. Coating layer 220 will generally have a thickness of from 1-20 nm. The second material 210 can have a thickness ranging from 1 nm to much greater, such as a micron sized thickness.

A specific example of an embodiment in accordance with FIG. 2B comprises a target 30 (FIG. 1) including nanoparticles 200 of ¹⁰⁰Mo having an average diameter of from 5-20 nm, which are optionally coated with a coating layer 220 that comprises aluminum, silicon-carbide, or carbon, as specified above. Surrounding coating layer 220 is the second material 210, which comprises a carbon species or compound, such as polytetrafluoroethylene (PTFE). After irradiation, the second material 210 can be separated from the nanoparticles 200 by dissolving the second material 210 in an appropriate solvent and separating the nanoparticles 200 from the dissolved second material 210 using filtration, centrifugation, or other methods. The product radioisotope can then be harvested from the isolated second material 210 by evaporating the carbon species or compound, e.g., PTFE.

A further specific example of an embodiment in accordance with FIG. 2B comprises a target 30 including nanoparticles 200 of ¹⁰⁰Mo having an average diameter of from 5-20 nm, which are optionally coated with a coating layer 220 that comprises aluminum, silicon-carbide, or carbon, specified above. The second material 210 comprises a species that is chemically distinct from ¹⁰⁰Mo, such as platinum, which can have a thickness of from 1-20 nm After irradiation, the second material 210 containing the desired product radioisotope can be separated from the first nanomaterial 200, and the product radioisotope can be harvested accordingly.

In a similar but alternative embodiment (not depicted in FIG. 2B), the second material can be nanoparticles positioned adjacent or near the first nanomaterial, which also includes nanoparticles. For example, ¹⁰⁰Mo nanoparticles having an average diameter of from 5-20 nm can be coated with a 1-5 nm layer of gold or platinum and positioned adjacent to the second material comprising nanoparticles of a material such as iron, for example, iron nanoparticles having a diameter of from 1-50 nm After irradiation, the iron nanoparticles (containing the desired product radio-isotope), can be separated from the ¹⁰⁰Mo nanoparticles using filtration, centrifugation, or other suitable methods. Advantageously, iron nanoparticles can be separated from the ¹⁰⁰Mo nanoparticles using magnetic separation. Product radioisotope can then be harvested from the isolated iron nanoparticles through chemical or physical methods known in the art.

Referring now to the exemplary embodiment depicted in FIG. 2C, target 30 (FIG. 1) can include nanowires 300 as the first nanomaterial having a diameter of 100 nm or less. Nanowires 300 can be positioned within a matrix containing the second material as a wire or tube 310. Again, nanowires 300 can optionally be coated with a coating layer (not shown in FIG. 2C) to prevent unwanted escape of unreacted target isotope that is knocked out of the nanowires 300 by ejecting product radioisotope.

A specific example of an embodiment in accordance with FIG. 2C comprises a target 30 (FIG. 1) including ¹⁰⁰Mo nanowires 300 having a diameter of from 5-20 nm, which are embedded within a matrix of the second material that comprises carbon nano-tubes 310. After irradiation, the second material can be dissolved in a suitable solvent, leaving nanowires 300 in place. Product radioisotope can then be harvested from the second material, for example by evaporating carbon nanotubes 310.

Various modifications and variations can be made to the devices, compositions, and methods described herein. Other aspects of the devices, compositions, and methods described herein will be apparent from consideration of the specification and practice of the devices, compositions, and methods disclosed herein. It is intended that the specification and examples be considered as exemplary.

### EXAMPLES

The following examples are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

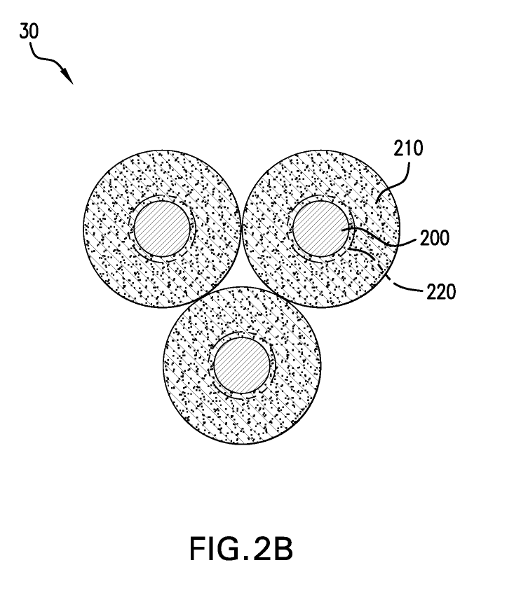

The following example describes theoretical calculations relevant to the irradiation device and method disclosed herein, with specific reference to target isotope ¹⁰⁰Mo, which is transmutated into product radioisotope ⁹⁹Mo. The energy spectrum of photo-produced ⁹⁹Mo ions depends on the incident Bremsstrahlung gamma spectrum, target, and cross sectional area of the photo-nuclear reaction. Energy of the recoiled ⁹⁹Mo ions during the ¹⁰⁰Mo(γ,n)⁹⁹Mo reaction can be calculated using a statistical model. The ⁹⁹Mo recoil spectrum, which is shown in FIG. 3, is calculated by multiplying neutron recoil spectra by appropriate kinematic factors associated with conservation of momentum.

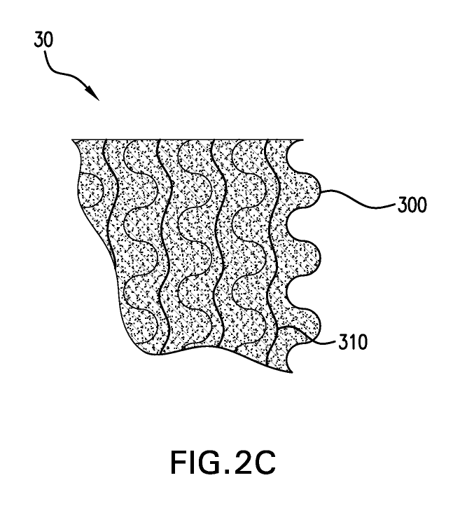

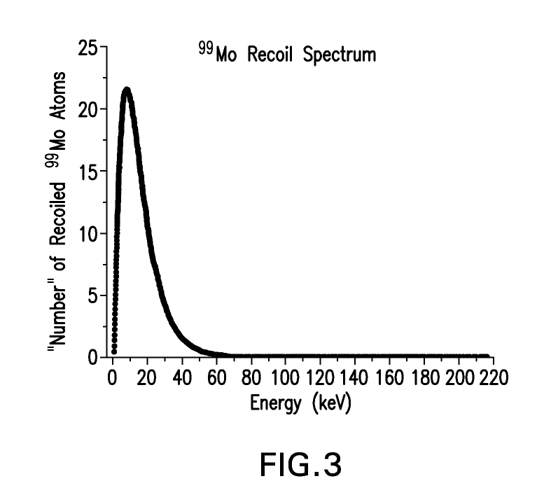

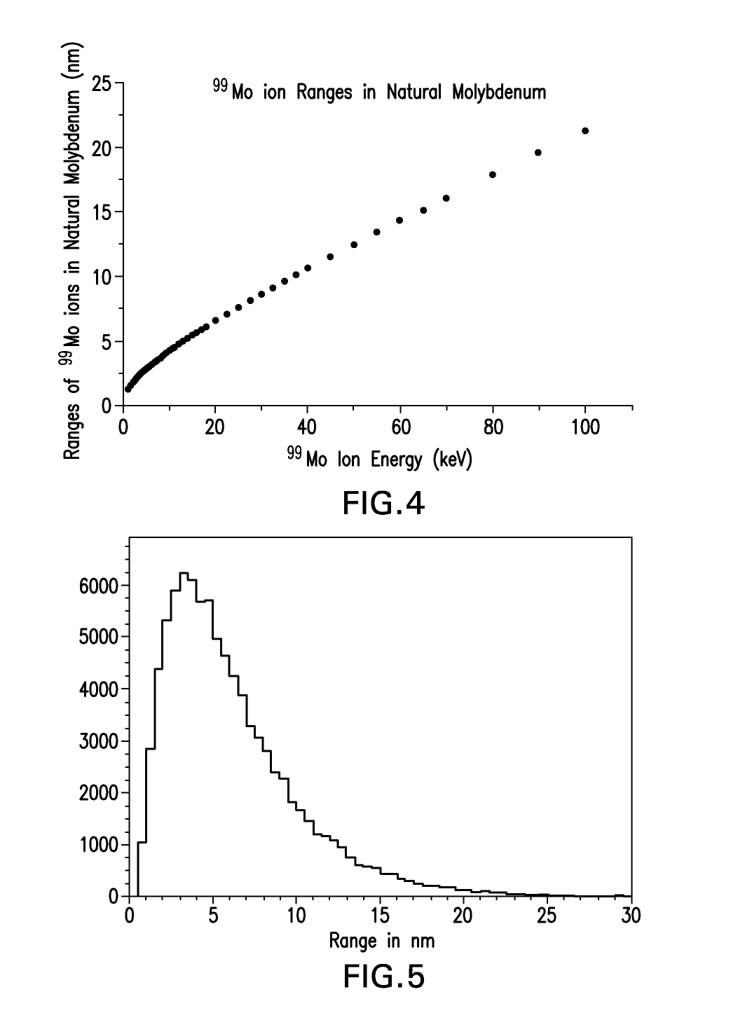

SRIM (The Stopping and Range of Ions in Matter) software (by James F. Ziegler) was used to calculate ranges of ⁹⁹Mo ions in natural molybdenum as a function of energy, which plotted in FIG. 4. The range of recoiling ⁹⁹Mo with an energy of about 10 keV (close to the peak energy of recoil spectrum) in natural molybdenum was found to be less than 5 nm Bremsstrahlung-weighted path-length of recoiling ⁹⁹Mo was also calculated and is plotted in FIG. 5. SRIM was used to estimate ⁹⁹Mo escape fraction as a function of particle size. Particles having the shape of a cube were simulated. The resulting plot from these calculations is shown in FIG. 6.

Based on the above calculations, a certain fraction of photo-produced ⁹⁹Mo ions escape a nanomaterial target and get stopped in the catcher material, or second material as defined herein. This fraction drops as the target particle size increases. The smaller the target particle size, the larger the escape fraction. Escaping ⁹⁹Mo ions can also knock out stable molybdenum (¹⁰⁰Mo) atoms, some of which can also escape out of the target nanomaterial and travel into the catcher material (second material). For a (20 nm)³ size ¹⁰⁰Mo particle, it was calculated that 56% of the photo-produced ⁹⁹Mo escapes the target nanomaterial along with 26 times more stable molybdenum atoms.

As a solution to escaping ¹⁰⁰Mo atoms, energy differences between ¹⁰⁰Mo and ⁹⁹Mo can be taken into account. The energy spectrum of ¹⁰⁰Mo ions has a spike at low energies (88% of the ions have energy <150 eV), whereas ⁹⁹Mo ions do not have such a spike. This difference between the energy spectra of ⁹⁹Mo and ¹⁰⁰Mo can be used to increase the number of ⁹⁹Mo ions that escape, relative to escaping ¹⁰⁰Mo atoms. This can be achieved by coating the ¹⁰⁰Mo particles with a coating layer that will stop most or all of the escaping ¹⁰⁰Mo. Various coating layers and corresponding calculated ⁹⁹Mo and ¹⁰⁰Mo escape fractions are listed in Table 3.

TABLE 3
⁹⁹Mo escape fraction vs. stable ¹⁰⁰Mo escape fraction
for a (20 nm)³ cube of natural molybdenum (calculated).

| Coating | ⁹⁹Mo escape fraction | ¹⁰⁰Mo escape fraction |
|---|---|---|
| None | 0.56 | 26 |
| 2 nm Au | 0.26 | 0.15 |
| 5 nm Au | 0.09 | 0.01 |
| 10 nm Au | 0.0018 | 0 |
| 2 nm Cu | 0.29 | 0.14 |
| 5 nm Cu | 0.1 | 0.014 |
| 10 nm Cu | 0.017 | 0 |
| 2 nm Al | 0.44 | 0.57 |
| 5 nm Al | 0.29 | 0.1 |
| 10 nm Al | 0.134 | 0.016 |
| 5 nm SiC | 0.3 | 0.12 |
| 5 nm C | 0.3 | 0.12 |

### Example 2

The following experimental studies were carried out to produce ⁹⁹Mo from ¹⁰° Mo. An electron beam was produced using a linear electron accelerator located at the Idaho Accelerator Center (Pocatello, Id., U.S.A.). The accelerator operates in pulsed mode and can give an electron beam of energy up to 44 MeV. For ⁹⁹Mo production, an electron beam having an average energy of 30 MeV and a power of about 5 to 6 kW (peak current is 250 mAmps, pulse width is 2.5 microseconds, and repetition rate is 300 Hz). The electron beam impinged upon a thin tantalum converter, which included a set of 0.5 mm tantalum disks, resulting in Bremsstrahlung radiation. The Bremsstrahlung photons were used to activate the targets of interest. The photon flux produced by the accelerator at 30 MeV and 5 kW was approximately 1.3×10¹² photons/sec/cm²/kW (total for the energy range 8.3-30 MeV).

Samples were placed in the photon beam for a pre-determined amount of time, based on the desired amount of activation. After the activation, target and catcher (second material) foils were separated and activities were measured by conventional gamma spectroscopy. For convenience, twenty-five micrometer thick natural molybdenum foil and thin 1.5 micrometer aluminum foil (Alfa Aesar, Ward Hill, Mass., U.S.A.) were used in the experiment 0.1 mm indium and nickel foils were used to monitor photon flux on each target (molybdenum foil—stock number 10042, aluminum thin foil—stock number 42625, indium foil—stock number 11386 and nickel foil—stock number 44821).

Four sets of samples were prepared. Set 1 included 101 pieces of 1 cm by 1 cm aluminum thin foils and 100 pieces of 1 cm by 1 cm molybdenum foils, which were stacked in alternating order. This target assembly was activated in the 30 MeV electron beam Bremsstrahlung for 15 hours. The aluminum and molybdenum foils were separated at the end of irradiation and the total molybdenum mass transfer was measured in the aluminum.

Set 2 included 101 pieces of 1 cm by 1 cm aluminum thin foils and 100 pieces of 1 cm by 1 cm molybdenum foils, which were stacked in alternating order. This target assembly was irradiated in the 7 MeV electron beam Bremsstrahlung for 15 hours. Total dose delivered to the target was estimated to be 2 MGy. Energy of the electron beam (7 MeV) was chosen such that it was below the threshold of the ¹⁰⁰Mo(γ, n)⁹⁹Mo reaction, which is approximately 8:3 MeV. Thus, ⁹⁹Mo in the target was not activated. The aluminum and molybdenum foils were separated after irradiation and aluminum foils were activated in 30 MeV beam for 15 hours, under the same conditions as sets 1, 3, and 4. Molybdenum mass in the catcher was measured (friction mass transfer+radiolytic mass transfer).

Set 3 included 101 pieces of 1 cm by 1 cm aluminum thin foils and 100 pieces of 1 cm by 1 cm molybdenum foils, which were stacked in alternating order. This target assembly was left at room temperature for approximately 24 hours. The aluminum and molybdenum foils were then separated and aluminum foils were activated under the same conditions as Sets 1 and 2. Molybdenum mass transfer due to friction/diffusion was measured.

Set 4 included 101 pieces of 1 cm by 1 cm aluminum thin foils, which were stacked together and activated in the 30 MeV electron beam Bremsstrahlung for 15 hours. Total molybdenum mass was calculated in aluminum foils, and this value was subtracted from the mass transfer results for sets 1, 2, and 3. A piece of 1 cm by 1 cm molybdenum foil of a known mass was activated under the same conditions as a mass control sample. Molybdenum mass in the catcher foils was calculated by measuring the ⁹⁹Mo activity and comparing it to that in the control molybdenum foil (see below for exception for set 1). Incident photon flux was different for control and catcher foils. These fluxes were measured, and mass transfer results were normalized to the incident photon flux. After the photon energy spectra were obtained from each set of the samples, they were analyzed for activity. The results are summarized in Table 4 below:

TABLE 4
Total ⁹⁹Mo activity (nCi) in Foil stacks 1-4.

| Foil Stack | ⁹⁹Mo activity (nCi) |
|---|---|
| 1 | 256 +/− 1 |
| 2 | 2.15 +/− 0.06 |
| 3 | 1.77 +/− 0.05 |
| 4 | 0.040 +/− 0.004 |

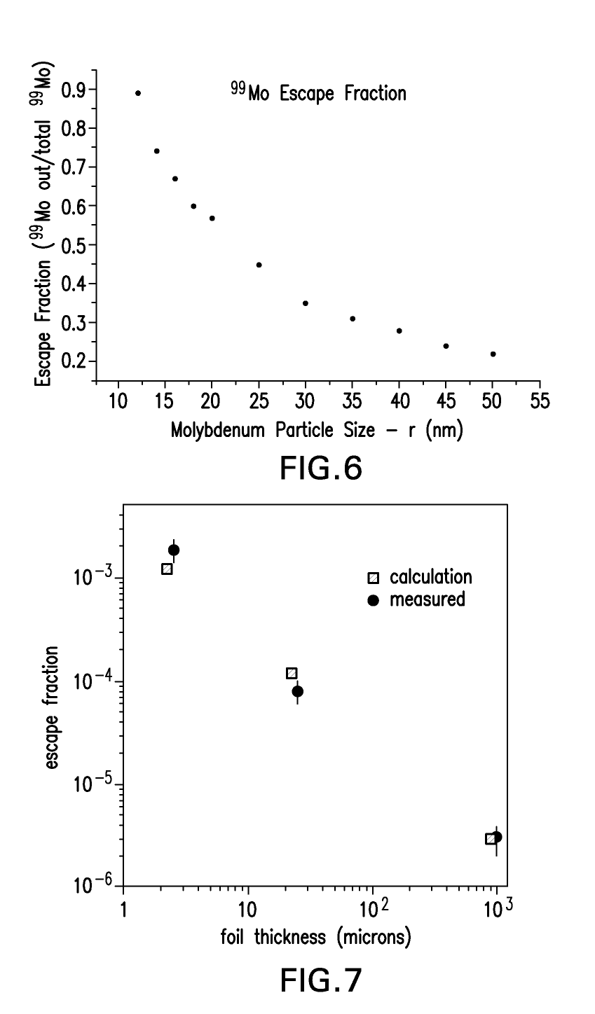

Calculated and measured escape fractions as a function of foil thickness is plotted in FIG. 7. The results of these experiments show that the activity of catchers in foil stack 1 is higher than in the other stacks, and that this activity results from recoil of the ⁹⁹Mo atoms into the catcher (second material).

What is claimed is:

1. An irradiation device, comprising:
an electron accelerator for supplying accelerated electrons;
a converter comprised of a high Z material upon which the accelerated electrons impinge and which converts accelerated electron energy into gamma radiation;
a target upon which the gamma radiation impinges, the target comprising (i) a first nanomaterial comprising an isotope and having at least one dimension that is 100 nm or less, and (ii) a second material adjacent to the first nanomaterial that accepts a radioisotope transmutated from the isotope of the first nanomaterial that is ejected from the first nanomaterial when the gamma radiation impinges on the target;
and one or more cooling systems for cooling the converter and target during operation of the device.

2. The device of claim 1, further comprising a beam hardener between the converter and the target for removing residual electrons that pass through the converter.

3. The device of claim 1, wherein the second material is a nanomaterial having at least one dimension that is 100 nm or less.

4. The device of claim 1, wherein the target further comprises a third material surrounding the first nanomaterial.

5. The device of claim 1, wherein the first nanomaterial comprises a nanowire.

6. The device of claim 1, wherein the first nanomaterial comprises a nanosheet.

7. The device of claim 1, wherein the first nanomaterial comprises a nanoparticle.

8. The device of claim 1, wherein the isotope of the first nanomaterial is selected from ¹⁰⁰Mo, ¹⁹F, ⁶⁵Cu, ⁶⁸Zn, and ⁸⁹Y.

9. A method for producing a radioisotope, comprising: irradiating a target with gamma radiation, the target comprising (i) a first nanomaterial comprising a target isotope, and (ii) a second material adjacent to the first nanomaterial which accepts a radioisotope transmutated from the target isotope of the first nanomaterial which is ejected from the first nanomaterial when the gamma radiation impinges on the target.

10. The method of claim 9, further comprising: separating the second material containing the radioisotope from the first nanomaterial.

11. The method of claim 10, further comprising separating the radioisotope from the second material.

12. The method of claim 9, wherein the gamma radiation is generated by supplying accelerated electrons onto a converter comprised of a high Z material.

13. The method of claim 9, wherein the second material is a nanomaterial having at least one dimension that is 100 nm or less.

14. The method of claim 9, wherein the target further comprises a third material surrounding the first nanomaterial.

15. The method of claim 9, wherein the first nanomaterial comprises a nanowire.

16. The method of claim 9, wherein the first nanomaterial comprises a nanoparticle.

17. The method of claim 9, wherein the isotope of the first nanomaterial is selected from ¹⁰⁰Mo, ¹⁹F, ⁶⁵Cu, ⁶⁸Zn, and ⁸⁹Y.
